(19) United States
(12) Patent Application Publication
(10) Pub. No.: US 2009/0323575 A1
(43) Pub. Date: Dec. 31, 2009

(54) METHOD AND APPARATUS FOR MULTICASTING WITHIN A WIRELESS COMMUNICATION NETWORK

(75) Inventors: Zhu Li, Palatine, IL (US); Ethan Y. Chen, Wilmette, IL (US); Faisal Ishtiaq, Chicago, IL (US); Hua Xu, Lake Zurich, IL (US); John M. Harris, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/147,809

(22) Filed: Jun. 27, 2008

(51) Int. Cl. H04H 20/71

(52) U.S. Cl. 370/312

(57) ABSTRACT

A number of uplink transmissions from multiple remote devices is received. The remote devices correspond to a single network node, and each of the uplink transmissions corresponds to a request for content. A subset of remote devices whose uplink transmissions correspond to requests for common content is identified and a Quality of Service (QoS) level corresponding to the number of remote devices in the identified subset is determined. The common content is transmitted to the single network node at the determined QoS level.

### FIELD OF THE DISCLOSURE

The present disclosure relates generally to a wireless communication network and more specifically to a method and apparatus for multicasting within a wireless communication network.

### BACKGROUND

Wireless communication networks are widely deployed to provide various communication services such as voice, packet data, multi-media broadcast, text messaging, and so on. These wireless communication networks may be multiple-access systems capable of supporting communication for multiple users by sharing the available network resources. Examples of such multiple-access systems include Code Division Multiple Access (CDMA) systems, Time Division Multiple Access (TDMA) systems, Frequency Division Multiple Access (FDMA) systems, and Orthogonal Frequency Division Multiple Access (OFDMA) systems. A CDMA system may implement Wideband CDMA (W-CDMA), cdma2000, and so on. W-CDMA is described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. WiMAX (Worldwide Interoperability for Microwave Access)-based systems are being designed and developed for operation in licensed bands, such as 2.3 GHz, 2.5 GHz, 3.3 GHz, 3.5 GHz etc.

A multicast transmission is known to be a transmission sent to a group of terminals within a multicast coverage area. A wireless communication network may send multicast transmissions that are variable in nature. For example, multicast transmissions may have variable data rates that change over time. For the wireless communication network, it may be challenging to allocate system resources for such transmissions in an efficient manner.

Accordingly, there is a need for an improved and more efficient method and apparatus for multicasting within a wireless communication network.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram illustrating a wireless communication system in accordance with some embodiments.

FIG. 2 is a call flow diagram illustrating an operation of the wireless communication system of FIG. 1, in accordance with some embodiments.

FIG. 3 is a call flow diagram illustrating an operation of the wireless communication system of FIG. 1, in accordance with other embodiments.

FIG. 4 is a flowchart illustrating a method of operation of the system of FIG. 1, in accordance with some embodiments.

FIG. 5 is a flowchart illustrating a method of operation of the system of FIG. 1, in accordance with some embodiments.

FIG. 6 is a flowchart illustrating a method of operation of the system of FIG. 1, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, a method for multicasting within a wireless communication network includes receiving a plurality of uplink transmissions from a plurality of remote devices, the plurality of remote devices corresponding to a single network node, where each of the plurality of uplink transmissions corresponds to a request for content. The method further includes identifying a subset of remote devices from the plurality of remote devices whose uplink transmissions correspond to requests for common content, determining a Quality of Service (QoS) level corresponding to number of remote devices in the identified subset, and transmitting the common content to the single network node at the determined QoS level.

In another embodiment, the method includes receiving a plurality of uplink transmissions from a plurality of remote devices, where each of the plurality of uplink transmissions corresponds to a request for content from a content source. The method further includes identifying a subset of remote devices from the plurality of remote devices whose uplink transmissions correspond to requests for common content. The method also includes determining an estimated QoS level corresponding to number of remote devices in the identified subset and establishing a multicast session with the subset of remote devices for multicasting the common content at an available QoS level when using a shared downlink communication signal. Advantages of the various embodiments include: better streaming quality to remote devices; better radio resource utilization; cross layer optimization for increased content delivery where a PHYSICAL layer is used for detection of remote devices, an APPLICATION layer is used for adapting a data rate corresponding to the content, and a MAC layer is used for dynamic carrier combining. Those skilled in the art will realize that the above advantages and other advantages described herein are merely illustrative and are not meant to be a complete rendering of all of the advantages of the various embodiments.

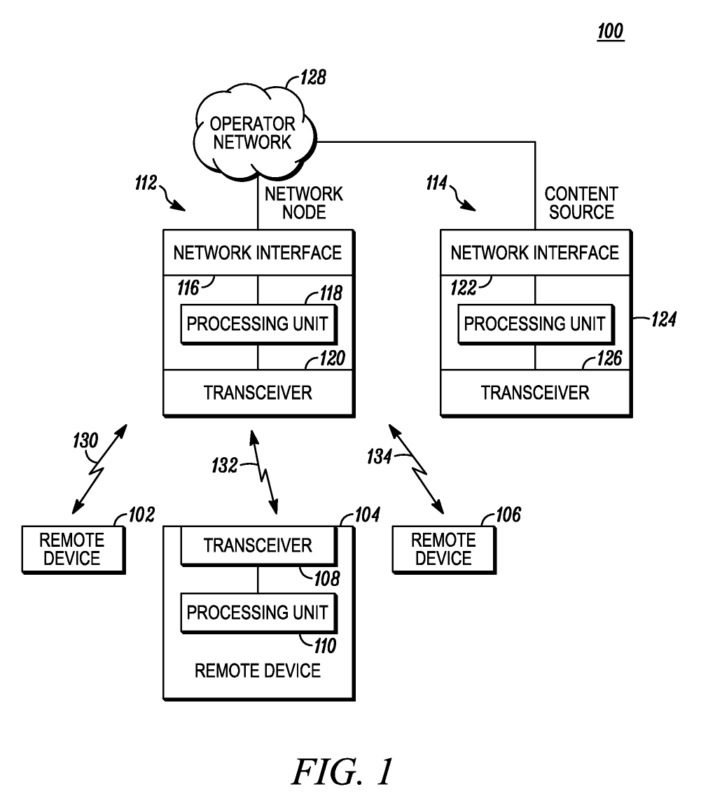

Referring now to the figures, FIG. 1 is a system diagram illustrating a wireless communication system 100 in accordance with some embodiments. At present, standards bodies such as OMA (Open Mobile Alliance), 3GPP (3rd Generation Partnership Project), 3GPP2 (3rd Generation Partnership Project 2), IEEE 802 (Institute of Electrical and Electronics Engineers), and Worldwide Interoperability for Microwave Access (WiMAX) Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/respectively.) Communication system 100 represents a system having an architecture in accordance with one or more of the WiMAX technologies, suitably modified to implement the present invention. Alternative embodiments of the present invention may be implemented in communication systems that employ other or additional technologies such as, but not limited to, those described in the OMA, 3GPP2, IEEE 802, and/or 3GPP2 specifications.

Communication system 100 is depicted in a very generalized manner. For example, system 100 is shown to simply include remote devices 102, 104, 106, a network node 112, a content source 114, and an operator network 126. The network node 112 is shown providing network services to remote devices 102, 104, 106 using wireless interfaces 130, 132, 134, respectively. Wireless interfaces 130, 132, 134 are in accordance with the particular access technology supported by the network node 112. For example, they may all utilize the same technology such as one based on IEEE 802.16, or they may utilize different access technologies. A content source refers to an application server that delivers applications and/or content to a remote device. It should be understood that the content source 114 may also be termed as a network node for some of the embodiments.

Each remote device 102, 104, 106 includes the capability to communicate with the network node 112 through one or more wireless communication protocols such as Advanced Mobile Phone System (AMPS), Code division multiple access (CDMA), Time division multiple access (TDMA), Global System for Mobile communications (GSM), Integrated Digital Enhanced Network (iDEN), General Packet Radio Service (GPRS), Enhanced Data rates for GSM Evolution (EDGE), Universal Mobile Telecommunications System (UMTS), Wideband Code Division Multiple Access (WCDMA), Code division multiple access 2000 (CDMA2000), and their variants. Each remote device 102, 104, 106 may also use ad-hoc communication to connect directly to each other and to execute applications that may utilize the ad-hoc connection.

Further, it should be understood that the present invention is not limited to mobile remote devices. Other types of wireless access terminals which may include fixed wireless terminals may be used. It should be understood that the term “remote device” in the claims and description below includes both mobile wireless communication devices (e.g., mobile phones, wireless handheld computers), stationary wireless terminals (e.g., fixed wireless router) or other electronic battery operated devices coupled to a network.

Those skilled in the art will recognize that FIG. 1 does not depict all of the physical fixed network components that may be necessary for system 100 to operate but only those system components and logical entities particularly relevant to the description of embodiments herein. For example, FIG. 1 depicts network node 112 comprising processing unit 118, transceiver 120, and network interface 116. The remote device 104 comprises a transceiver 108 and a processing unit 110. For a better understanding, exemplary internal components of the remote device 104 are described hereafter. However, it should be understood that the internal components of remote device 104 may also be found in the remote devices 102, 106. FIG. 1 also depicts a content source 114 comprising a network interface 122, a processing unit 124, and a transceiver 126.

Remote devices 102, 104, 106, network node 112, and content source 114 are shown communicating via technology-dependent, wireless interfaces. Remote devices, subscriber stations (SSs) or user equipment (UEs), may be thought of as mobile stations (MSs), mobile subscriber stations (MSSs) or mobile nodes (MNs). In addition, remote device platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). Further, depending on the embodiment, any of remote devices 102, 104, 106, may additionally comprise a keypad (not shown), a speaker (not shown), a microphone (not shown), and/or a display (not shown). Processing units, transceivers, keypads, speakers, microphones, and displays as used in remote devices, network nodes, and/or content sources are all well-known in the art.

For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, remote devices 102, 104, 106, network node 112, and content source 114 represent known devices that have been adapted, in accordance with the description herein, to implement multiple embodiments of the present invention. Furthermore, those skilled in the art will recognize that aspects of the present invention may be implemented in and across various physical components and none are necessarily limited to single platform implementations. For example, a network node may be implemented in or across one or more RAN components, such as a base transceiver station (BTS) and/or a base station controller (BSC), a Node-B and/or a radio network controller (RNC), or an HRPD AN and/or PCF, or implemented in or across one or more access network (AN) components, such as an access service network (ASN) gateway and/or ASN base station (BS), an access point (AP), a wideband base station (WBS), and/or a WLAN (wireless local area network) station.

Operationally, in accordance with some embodiments, the remote devices 102, 104, 106 use the network interfaces 130, 132, 134, respectively, to request content from the content source 114. The requests for content are forwarded, via the network node 112 using an operator network 126, to the content source 114. The processing units of the remote devices 102, 104, 106 via their respective transceivers transmit a request to the content source 114. The network node 112 and/or the content source 114 may determine that the content requested by each remote device 102, 104, 106 is, the same, or common to the remote devices 102, 104, 106. In this case, the network node 112 and/or the content source 114 initiates a carrier combining sequence in which the carriers or sub-channels corresponding to each of the remote devices 102, 104, 106 are combined to form a shared channel to be used by the network node 112 and/or the content source 114 to transmit the common content at a Quality of Service (QoS) level.

The common content may relate to common video information, common audio information, or a common combination of video and audio information, and group e-mail, group call, group presence information or any common data that a plurality of remote devices may require to download from the content source 114. The QoS level is the level at which the common content is delivered to the plurality of remote devices requesting for the common content. The QoS level corresponds to number of remote devices that have requested for the common content.

In one embodiment, the QoS level increases with the increase in the number of remote devices that join a multicast session for receiving the common content. For example, a shared downlink radio frequency channel is used by the content source to deliver the common content. In this case, with addition of each remote device to the multicast session usage of the shared channel increases and therefore the QoS level is increased with increase in at least one of data rate, lower delay, and higher call admission priority. On the other hand, with subtraction of each remote device from the multicast session the usage of the shared channel decreases and therefore the QoS level is also decreased.

When using a shared downlink communication channel, an increase in the number of remote devices receiving the common content over the shared communication channel results in small or zero increase in radio frequency (RF) communication costs. As a result, as the number of remote devices receiving content over the shared communication channel increases, the ratio of services delivered per RF communication cost increases. In other words, there is an increase in the number of users served by the shared communication channel per RF communication resource used.

In a network node-focused embodiment, processing unit 118 via the transceiver 120 receives a plurality of uplink transmissions from a plurality of remote devices where each of the plurality of uplink transmissions corresponds to a request for content. The processing unit 118 then determines a subset of remote devices whose uplink transmissions correspond to common content. The processing unit 118, via the network interface 116 and/or transceiver 120 may also forward the requests to the content source 114 for carrying out the process of determining a subset of remote devices whose uplink transmissions correspond to common content. The processing unit 118 establishes a multicast session with the subset of remote devices and multicasts, via the transceiver, the common content at an available QoS level using a shared downlink communication signal to the subset of remote devices.

In some of the embodiments, the network node 112 or the content source 114 determines whether the number of remote devices requesting the common content are above a first threshold value. When the number of remote devices requesting for the common content is above the first threshold value, the QoS level includes at least one of a higher data rate for multicasting the common content, a lower delay, a smaller packet error rate, or a higher call admission priority. On the other hand, when the number of remote devices requesting for the common content is less than or equal to the first threshold value, the QoS level then includes at least one of a lower data rate for multicasting the common content, a higher delay, or a lower call admission priority. Call admission priority is a priority assigned to a remote device by a network node. When the system is relatively loaded, calls with lower admission control priority are blocked, while other calls with higher admission control priority are accepted.

In another embodiment, with continuous addition of remote devices in the multicast session the number of remote devices reaches a second threshold value. In this case, the content source 114 and/or the network node 112 may then maintain the QoS level with addition of any other remote device to the multicast session.

In one embodiment, the process of determining whether a requestor remote device should be a part of the existing multicast session varies from one embodiment to the next. Different embodiments may strive to achieve different degrees of fairness among the remote devices who are contending for the common content, and/or different embodiments may use different rules or techniques to achieve a particular degree of fairness. Whether the requester remote device is granted permission to be a part of the existing session may also depend on the particular number of remote devices contending, the relative amount of resources presently utilized by the remote devices who are a part of the session, the current loading conditions (e.g. an overloaded condition verses a lightly loaded condition) of particular network nodes and/or content sources, etc.

In one of the embodiments, if the number of remote devices requesting the common content reaches the second threshold value, the network node 112 and/or the content source 114 may then determine whether to add additional remote devices to an existing session. The network node 112 and/or the content source 114 may then add additional remote devices to the existing session based on their priority or available resource capability. For example, the remote devices with a higher priority will have more chances to be a part of the session as compared to the remote devices with a lower priority. The second threshold value in this case refers to a limit of remote devices that can be added to an existing session and/or a limit until the content source 114 has enough available resources to cater to any remote device that joins the existing session.

In one embodiment, the network node 112 or the content source 114 may block a requester remote device from joining the existing session based on various characteristics related to the system resources and the requestor remote device. For example, the network node 112 and/or the content source 114 may check for load on the network, signal strength of the requestor remote device, battery level of the requestor remote device, and other related characteristics. The requester remote device having a poor or degrading signal strength or a low battery may be blocked from joining the existing session. In another example, a remote device that is already a part of the session may also be blocked or ask to leave based on above discussed characteristics. In some embodiments, a network node and/or content source may block the requestor remote device from joining the session based on the traffic load on the network node and/or content source.

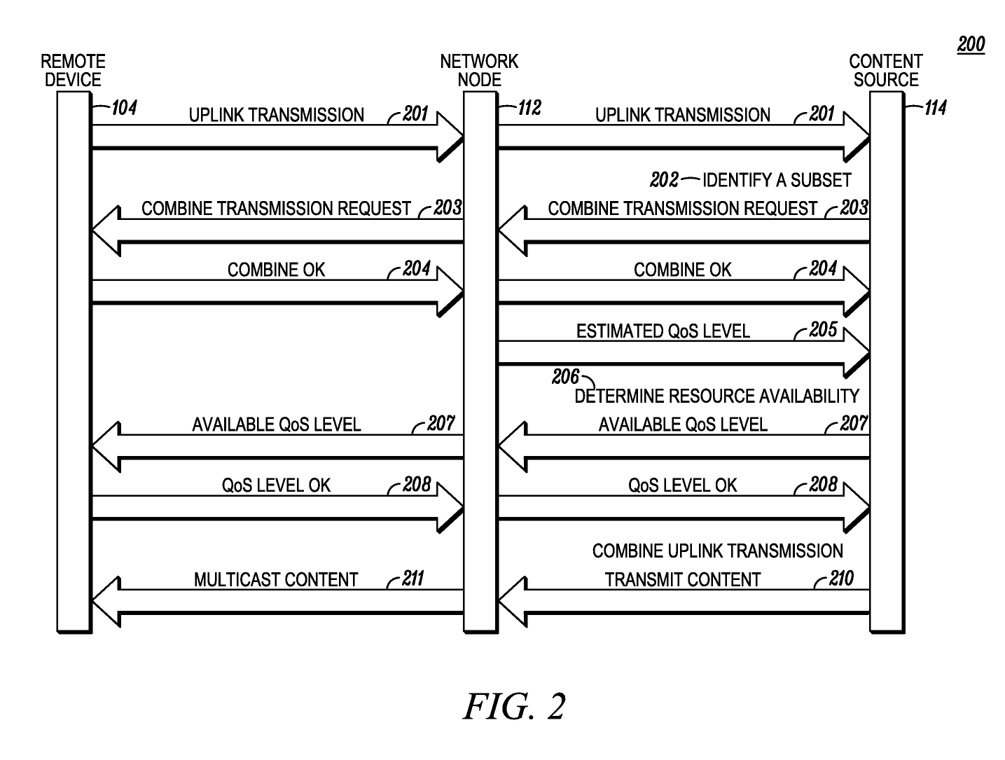

FIG. 2 is a call flow diagram 200 illustrating an operation of the wireless communication system of FIG. 1, in accordance with some embodiments. Call flow diagram 200 depicts functionality of the network node 112 and the content source 114 in accordance with some embodiments. Generally speaking, call flow diagram 200 is one specific approach for multicasting common content to a plurality of remote devices.

As illustrated by FIG. 2, the remote device 104 transmits (201) a request to the network node 112 for content from the content source 114. The request from the remote device 104 is received as an uplink transmission by the network node 112. The network node 112 then forwards (201) the request to the content source 114. The forwarded request from the network node 112 is received as an uplink transmission by the content source 114. In one embodiment, the content source 114 receives a plurality of uplink transmissions from a plurality of remote devices. The content source 114 then determines whether the plurality of uplink transmissions correspond to a single network node as do, for example, the uplink transmissions of remote devices 102, 104, 106 via the network node 112 and also whether those uplink transmissions correspond to requests for common content.

For example, remote devices 102, 104, 106 may request common content from the content source 114. The requests from remote devices 102, 104, 106 are received as a plurality of uplink transmissions from the network node 112. The content source 114 identifies (202) a subset of remote devices that requested for the common content. The content source 114 then transmits (203) a combine transmission request to the network node 112. The combine transmission request corresponds to the usage of a shared radio frequency downlink channel by the remote devices 102, 104, 106 requesting for the common content. To simplify the description, only remote device 104 is depicted as exchanging messages with the network node. However, it should be understood that any of the remote devices 102, 106 may perform the same operations. The network node 112 forwards the combine transmission request to each member of the subset of remote devices. In one embodiment, the sub-carriers corresponding to each member of the subset of remote devices are combined and the combine transmission request is generated by the content source 114.

Assuming approval, the network node 112 thereafter forwards (204) a combine OK, received from each member of the subset of remote devices, to the content source 114. The network node 112, based on the number of remote devices requesting common content, determines an estimated QoS level at which the network node 112 would multicast the common content to the subset of remote devices. The estimated QoS level corresponds to the number of remote devices in the subset. The network node 112, after determining the estimated QoS level transmits (205) the estimated QoS level to the content source 114. The content source 114 then determines (206) whether resources that are available are enough to support the estimated QoS level and transmits (207) an available QoS level to the network node 112.

The network node 112 forwards (207) the available QoS level to each of the remote devices of the subset. After receiving (208) a combine QoS level OK from each of the remote devices, the content source 114 combines (209) the uplink transmissions to utilize the shared downlink channel corresponding to the subset of remote devices and transmits (210) the common content to the network node 112 at the available QoS level. The network node 112 then multicasts the common content to the subset of remote devices at the available QoS level.

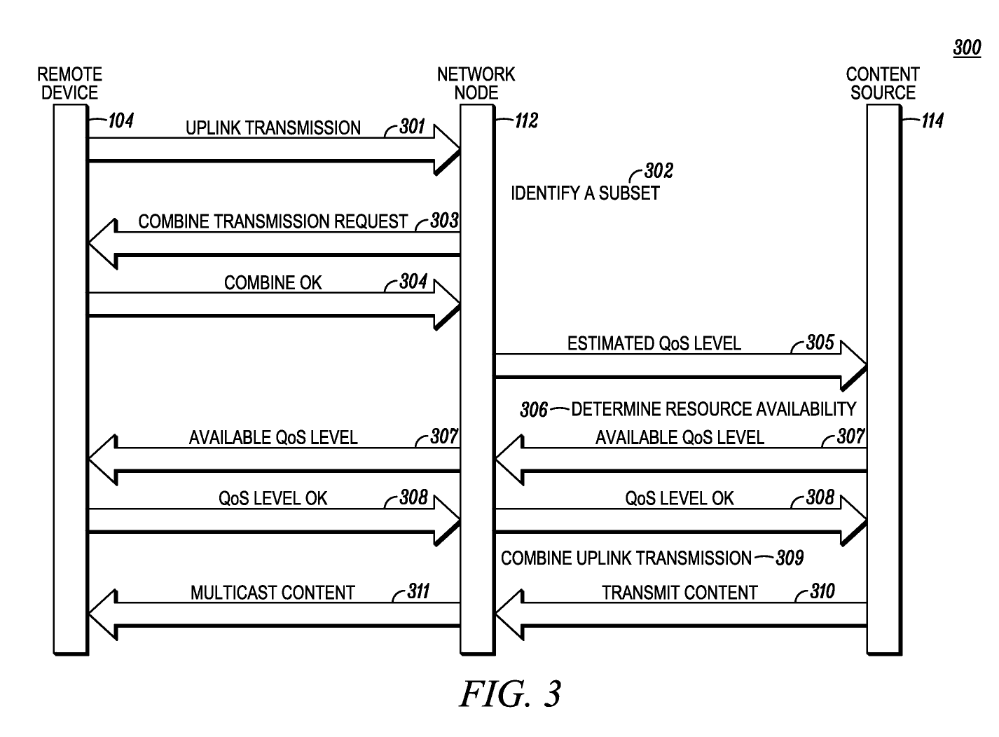

FIG. 3 is a call flow diagram 300 illustrating an operation of the wireless communication system of FIG. 1, in accordance with certain other embodiments. Call flow diagram 300 depicts functionality of the network node 112 and the content source 114 in accordance with certain embodiments. Generally speaking, call flow diagram 300 is another specific approach for multicasting common content to a plurality of remote devices.

As illustrated by FIG. 3, the remote device 104 transmits (301) a request to the network node 112 for content from the content source 114. The network node 112 determines whether a plurality of remote devices that are linked to the network node 112, have requested the same, i.e., common content. The network node 112 identifies (302) a subset of remote devices that correspond to the common content and transmits (303) a combine transmission request to each of the subset of remote devices. After receiving (304) a combine OK from each of the subset of remote devices, the network node 112 estimates a QoS level corresponding to the number of remote devices in the subset. The network node 112 then transmits (305) an estimated QoS level to the content source 114. The content source 114 then determines (306) whether it has available resources to support the estimated QoS level. Based upon available resources, the content source will transmit, via the network node 112, an available QoS level to the subset of remote devices (307). Assuming approval, the network node 112 forwards (308) QoS level OK, received from each member of the subset of remote devices, to the content source.

The network node 112 then combines (309) the uplink transmissions corresponding to each remote device that belong to the subset. The content source 114 transmits (310) the content at the available QoS level to the network node 112 and the network node 112 multicasts (311) the common content to the subset of remote devices at the available QoS level.

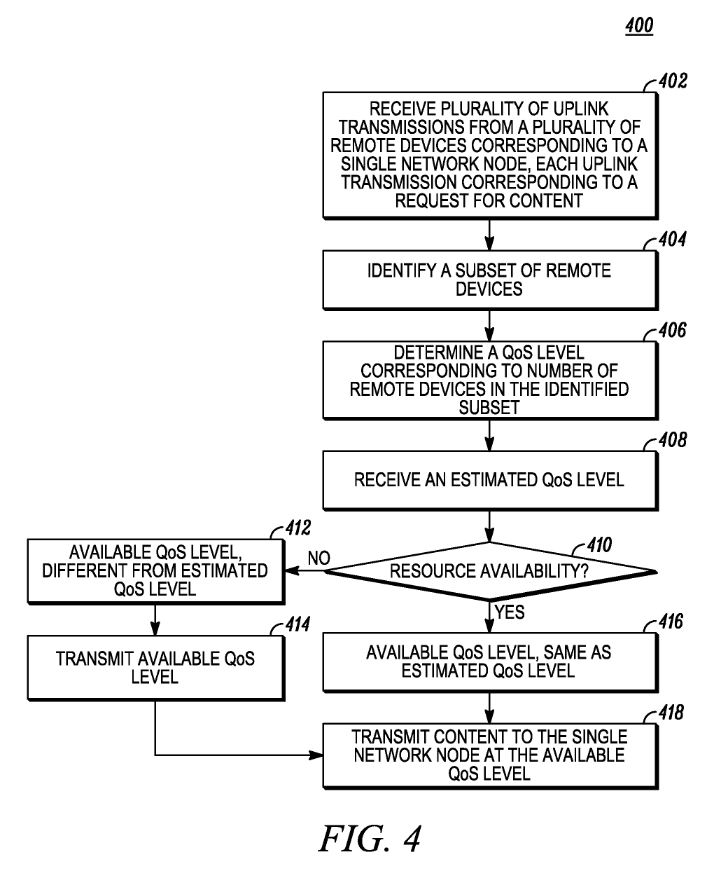

FIG. 4 is a flowchart 400 illustrating a method of operation for multicasting within a wireless communication network, in accordance with some embodiments. The flowchart 400 begins (402) with a content source receiving a plurality of uplink transmissions from a plurality of remote devices. The plurality of remote devices correspond to a single network node and each uplink transmission corresponds to a request for content. The content source determines (404) a subset of remote devices, where the subset includes the remote devices that correspond to the single network node and request common content from the content source. The content source then determines (406) a QoS level corresponding to number of remote devices in the identified subset. The single network node then forwards a combine transmission request to the subset of remote devices for acknowledgment.

The content source receives (408) an estimated QoS level from the single network node, in reply to the combination transmission request. After receiving the estimated QoS level, the content source determines (410) whether resources are available to support the estimated QoS level. The content source selects the QoS level from available levels such that the QoS level corresponds to the estimated QoS level. The content source selects (412) an available QoS level that is different than the estimated QoS level, if the resource availability does not support the estimated QoS level. The available QoS level is then transmitted (414) to the single network node and further to each member of the subset of remote devices by the single network node.

Otherwise, the content source selects (416) an available QoS level that is same as the estimated QoS level. In any case, the common content is transmitted (418) to the single network node at the available QoS level, which is then multicasted to the subset using the available QoS level. The single network node combines the carriers or the sub-channels corresponding to the subset of remote devices, respectively, and establishes a multicast session to multicasts the common content at the available QoS level on the shared downlink channel.

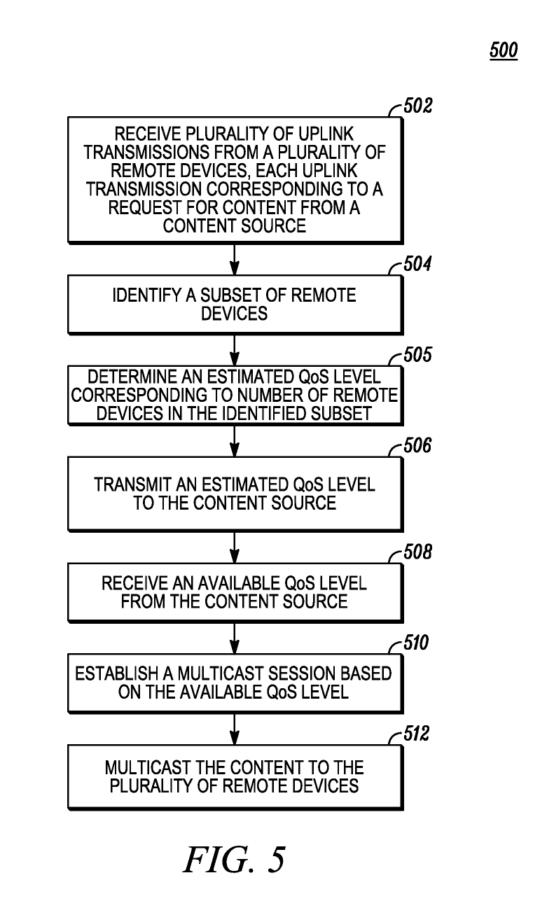

FIG. 5 is a flowchart 500 illustrating a method of operation for multicasting within a wireless communication network, in accordance with some embodiments. The flowchart 500 begins (502) with a network node receiving a plurality of uplink transmissions from a plurality of remote devices. Each uplink transmission corresponds to a request for content from a content source. The network node determines (504) a subset of remote devices from the plurality of remote devices that are requesting content and whose uplink transmissions correspond to requests for common content. The network node combines the carriers and/or the sub-channels corresponding to the subset of remote devices and determines (505) an estimated QoS level based upon the number of remote devices in the subset. The network node then transmits a combine transmission request to each of the subset of remote devices. The combine transmission request includes the estimated QoS level. After receiving an acknowledgement on the combine transmission request, the network node then transmits (506) the estimated QoS level to the content source. The content source checks the resource availability and calculates whether the content source has available resources to support the estimated QoS level. The network node receives (508) an available QoS level from the content source. In one embodiment, the available QoS level may be same as the estimated QoS level or different from the estimated QoS level. The available QoS level is generated based upon on the resource availability at the content source. The network node then establishes (510) a multicast session with the subset of remote devices and multicasts (512) the common content to the subset of remote devices at the available QoS level.

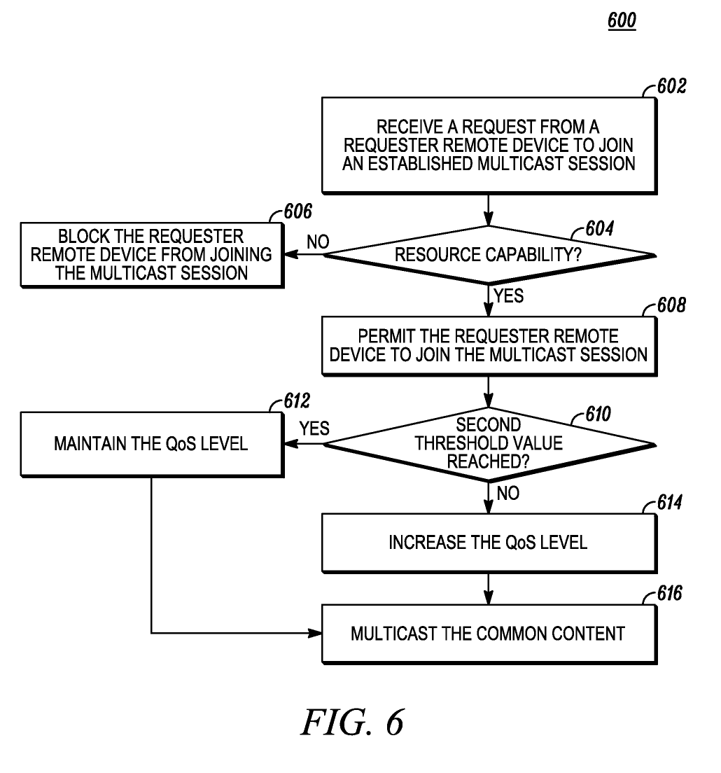

In one embodiment, as illustrated by FIG. 6, the network node and the content source receives (602) a request from a requester remote device to join an established multicast session. The network node and/or content source may then check the resource capability to determine (604) whether the requester remote device should be permitted to join or blocked from joining the multicast session. If the network node and/or the content source have sufficient resource capability to support the requester remote device, the requester remote device is permitted (608) to join the multicast session and the subset. In this case, as mentioned earlier, the QoS level for the multicast of the common content increases with addition of remote devices to the multicast session. In another case, the QoS level may be maintained at a constant level after the number of remote devices in the multicast session reaches the second threshold value. In any case, the common content is multicast (610) to the requester remote device at an increased QoS level when the number of remote devices in the subset is below the second threshold value or at an existing QoS level when the number of remote devices in the subset is above the second threshold value. The common content in both these cases is multicasted to the subset of remote devices at the increased QoS level or at the existing QoS level. This ability of the change in the QoS level based upon the number of remote devices in the multicast session provides better usage of the resources at the network node end and/or content source end. Otherwise, the requester remote device is blocked (606) from joining the multicast session.

In another embodiment, the network node and/or the content source may receive a request from a requester remote device to disjoin the multicast session. In this case, the QoS level may be decrease with subtraction of each remote device from the multicast session. In some embodiments, the increase and decrease in the QoS level may also depend upon the resource availability at the content source.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for multicasting within a wireless communication network, the method comprising:
receiving a plurality of uplink transmissions from a plurality of remote devices, the plurality of remote devices corresponding to a single network node, wherein each of the plurality of uplink transmissions corresponds to a request for a content;
identifying a subset of remote devices from the plurality of remote devices whose uplink transmissions correspond to requests for common content;
determining a Quality of Service (QoS) level corresponding to number of remote devices in the identified subset; and
transmitting the common content to the single network node at the determined QoS level.

2. The method of claim 1 further comprising
establishing a multicast session by the single network node for multicasting the common content to the subset of remote devices at the determined QoS level.

3. The method of claim 2, wherein the determined QoS level corresponds to at least one of a higher data rate, a lower delay, or a higher call admission priority when the number of remote devices in the subset is above a first threshold value.

4. The method of claim 2, wherein the determined QoS level corresponds to at least one of a lower data rate, a higher delay, or a lower call admission priority when the number of remote devices in the subset is below a first threshold value.

5. The method of claim 1, wherein determining the QoS level further comprising
receiving an estimated QoS level from the single network node corresponding to the number of remote devices in the identified subset; and
determining resource availability to support the estimated QoS level.

6. The method of claim 5 further comprising
selecting the QoS level from available levels such that the QoS level corresponds to the estimated QoS level.

7. The method of claim 2 further comprising
receiving a request from a requester remote device to join the multicast session; and
determining whether resource capability is capable of supporting the requester remote device.

8. The method of claim 7 further comprising
permitting the requester remote device to join the multicast session if the resource capability of the content source is capable of supporting the requester remote device.

9. The method of claim 8 further comprising
increasing the QoS level with addition of each requester remote device until the number of the remote devices in the multicast session reaches a second threshold value.

10. The method of claim 9 further comprising
maintaining the QoS level at a constant level with addition of each requester remote device after the number of remote devices in the multicast session reaches above the second threshold value.

11. The method claim of 7 further comprising
blocking the requester remote device from joining the multicast session if the resource capability of the content source is not capable of supporting the requester remote device.

12. The method of claim 2 further comprising
receiving a request from a requester remote device to disjoin the multicast session; and
decreasing the QoS level with subtraction of each remote device from the multicast session.

13. The method of claim 2, wherein a shared radio frequency channel is used for multicasting the common content to the subset of remote devices at the determined QoS level.

14. A method for multicasting within a wireless communication network, the method comprising:
receiving a plurality of uplink transmissions from a plurality of remote devices, wherein each of the plurality of uplink transmissions corresponds to a request for content from a content source;
identifying a subset of remote devices from the plurality of remote devices whose uplink transmissions correspond to requests for common content;
determining an estimated Quality of Service (QoS) level corresponding to number of remote devices in the identified subset; and
establishing a multicast session with the subset of remote devices for multicasting the common content at an available QoS level using a shared downlink communication signal.

15. The method of claim 13 further comprising
transmitting the estimated QoS level to the content source after determining the subset of remote devices.

16. The method of claim 14 further comprising
determining resource availability by the content source to support the estimated QoS level; and
receiving the available QoS level from the content source.

17. The method of claim 13, wherein the available QoS level corresponds to at least one of a lower data rate, a higher delay, or a lower call admission priority when the number of remote devices in the subset is below a first threshold value.

18. The method of claim 13, wherein the available QoS level corresponds to at least one of a higher data rate, a lower delay, or a higher call admission priority when the number of remote devices in the subset is above a first threshold value.

19. A network node, comprising:
a transceiver;
a processing unit, communicatively coupled to the transceiver,
adapted to receive, via the transceiver, a plurality of uplink transmissions from a plurality of remote devices, wherein each of the plurality of uplink transmissions corresponds to a request for content;
adapted to identify, a subset of remote devices from the plurality of remote devices whose uplink transmissions correspond to requests for common content;
adapted to determine, a Quality of Service (QoS) level corresponding to number of remote devices in the identified subset; and
adapted to transmit, via the transceiver, the common content to the single network node at the determined QoS level.

20. A network node, comprising:
a transceiver;
a processing unit, communicatively coupled to the transceiver,
adapted to receive, via the transceiver, a plurality of uplink transmissions from a plurality of remote devices, wherein each of the plurality of uplink transmissions corresponds to a request for content from a content source;
adapted to determine, a subset of remote devices from the plurality of remote devices whose uplink transmissions correspond to requests for common content;
adapted to determine, estimated Quality of Service (QoS) level corresponding to number of remote devices in the identified subset; and
adapted to establish, via the transceiver, a multicast session for multicasting the common content at an available QoS level using a downlink communication signal.
